(19) United States
(12) Patent Application Publication
(10) Pub. No.: US 2025/0348846 A1
(43) Pub. Date: Nov. 13, 2025

(54) SYSTEM AND METHOD FOR ASSET MANAGEMENT

(71) Applicant: HONEYWELL INTERNATIONAL INC., Charlotte, NC (US)

(72) Inventor: Jayalaxmi Telang, Bangalore (IN)

(21) Appl. No.: 18/658,995

(22) Filed: May 9, 2024

(51) Int. Cl. G06Q 10/109; G06F 11/32

(52) U.S. Cl. CPC G06Q 10/109; G06F 11/323

(57) ABSTRACT

Various embodiments described herein relate to systems and methods for managing service cases during asset maintenance in a facility. In this regard, asset data is received corresponding to at least one asset of a plurality of assets. A plurality of analytic models is determined that are enabled corresponding to the at least one asset based on the received asset data. Further, it is determined that a maintenance is scheduled for the at least one asset. Based on the determination, at least one analytic model from the plurality of analytic models is disabled. Further, a holistic view of the plurality of analytic models corresponding to each of the plurality of assets is provided.

### TECHNICAL FIELD

The present disclosure generally relates to an asset management system. More particularly, the present disclosure relates to controlling multiple analytic models corresponding to one or more assets during asset maintenance and providing a holistic view of the multiple analytic models in a facility.

### BACKGROUND

In critical facilities (e.g., airports, hospitals, government buildings, data centers, etc.,) there are many critical assets (e.g., chillers, air handler units, HVAC components, and/or like) that perform different operations. Any disruption in these assets would result in significant impact to business operations. Therefore, there exists a need to check and verify if such assets are performing as per expectations and requirements. Though the service technician may manually inspect certain external features, anomalies associated with internal components may go unobserved. Eventually, these challenges often result in unoptimized management of assets and/or under-utilization of resources at the facility.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments, in which:

FIG. 1 illustrates a schematic diagram showing a facility management system managing a plurality of facilities, in accordance with one or more embodiments of the present disclosure.

FIG. 2 illustrates a schematic diagram showing a building management system managing a facility of the plurality of facilities, in accordance with one or more embodiments of the present disclosure.

FIG. 3 illustrates a schematic diagram showing the facility management system managing the plurality of facilities, in accordance with one or more embodiments of the present disclosure.

FIG. 4 illustrates an exemplary block diagram of a framework of an Internet-of-Things (IoT) platform utilized in the facility management system, in accordance with one or more embodiments of the present disclosure.

FIG. 5 is an exemplary block diagram of a controller of the facility management system that may execute techniques in accordance with one or more embodiments of the present disclosure.

FIG. 6 is an exemplary block diagram illustrating an implementation of a service case management system in the facility, in accordance with one or more embodiments of the present disclosure.

FIG. 7 is an exemplary block diagram of an asset monitoring component of the service case management system, in accordance with one or more embodiments of the present disclosure.

FIG. 8 is an exemplary illustration of dashboard visualization data, in accordance with an aspect of the present disclosure.

FIG. 9 is an exemplary illustration of dashboard visualization data, in accordance with another aspect of the present disclosure.

FIG. 10 illustrates a flowchart showing a method in accordance with an aspect of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### SUMMARY OF THE INVENTION

The details of some embodiments of the subject matter described in this specification are set forth in the accompanying drawings and the description below. Other features, aspects, and advantages of the subject matter will become apparent from the description, the drawings, and the claims.

In accordance with an embodiment of the present disclosure, a system for managing service cases during asset maintenance is described. The system comprises a memory and a processor coupled to the memory. The processor is configured to receive asset data corresponding to at least one asset of a plurality of assets, determine a plurality of analytic models that are enabled corresponding to the at least one asset based on the received asset data, and determine that a maintenance is scheduled for the at least one asset. Further, the processor is configured to disable at least one analytic model from the plurality of analytic models during the schedule for the maintenance of the at least one asset. Furthermore, the processor is configured to re-enable the at least one analytic model after completion of the schedule for the maintenance of the at least one asset and render visualization of execution status of each of the plurality of analytic models corresponding to the at least one asset on a display device.

According to an aspect of the present disclosure, a method for managing service cases during asset maintenance is described. The method includes steps of receiving asset data corresponding to at least one asset of a plurality of assets, determining a plurality of analytic models that are enabled corresponding to the at least one asset based on the received asset data, determining that a maintenance is scheduled for the at least one asset, disabling at least one analytic model from the plurality of analytic models during the schedule for the maintenance of the at least one asset, re-enabling the at least one analytic model after completion of the schedule for the maintenance of the at least one asset; and rendering visualization of execution status of each of the plurality of analytic models corresponding to the at least one asset on a display device.

The above summary is provided merely for purposes of providing an overview of one or more exemplary embodiments described herein so as to provide a basic understanding of some aspects of the present disclosure. Accordingly, it will be appreciated that the above-described embodiments are merely examples and should not be construed to narrow the scope of the present disclosure in any way. It will be appreciated that the scope of the present disclosure encompasses many potential embodiments in addition to those summarized herein, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. Further, one or more embodiments described herein may be combined in any manner to realize the advantages discussed herein.

It is to be understood that both the foregoing general description and the following detailed description are exemplary and explanatory only and are not restrictive of the disclosed embodiments, as claimed.

### DETAILED DESCRIPTION

Reference will now be made in detail to embodiments, examples of which are illustrated in the accompanying drawings. In the following detailed description, numerous specific details are set forth in order to provide a thorough understanding of the described embodiments. However, it will be apparent to one of ordinary skill in the art that the described embodiments may be practiced without these specific details. Well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment, “according to one embodiment,” and the like generally mean that a particular feature, structure, or characteristic following the phrase may be included in at least one embodiment of the present disclosure, and may be included in more than one embodiments of the present disclosure (importantly, such phrases do not necessarily refer to the same embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

One or more embodiments of the present disclosure provides an “Internet-of-Things” or “IoT” platform for facility management that uses real-time accurate models and visual analytics to deliver recommendations that are actionable for sustained peak performance of the facility or an enterprise. The IoT platform is an extensible platform that is portable for deployment in any cloud or data center environment for providing an enterprise-wide, top to bottom view, displaying status of processes, assets, people, and/or safety. Further, the IoT platform of the present disclosure supports end-to-end capability to execute digital twins against process data and to translate the output into actionable recommendations, as detailed in the following description.

Facility managers who are responsible for keeping the facility (e.g., an airport, a hospital, or a data center, and/or the like) running without disruption are required to run different analytic models, such as rules and ML algorithms from different sources. The analytic models identify anomalies in the assets. For example, there may be a rule that performs comparison between two values. When a certain value, such as temperature value rises above or falls below a certain threshold, then the rule might trigger an alarm indicating there is some anomaly in the operation. Further, each asset has a maintenance schedule. During maintenance of the asset, different operational procedures are performed corresponding to the asset by the service technician. Due to these operational procedures, there may be some variations in the processing of telemetry data or there may be some variations in certain thresholds or setpoints. Therefore, when the maintenance of the asset is triggered, multiple service cases are generated due to multiple analytic models running on the asset. These service cases are erroneously populated in the list served to the service technician for resolution. The service technician or the technical manager spend more time in analyzing the service cases that are erroneously populated. Therefore, analyzing the erroneous or unwanted service cases, is a challenging and time-consuming task resulting in unoptimized utilization of resources and lowers productivity levels in the facility.

In some embodiments, the service technician in the facility may disable the analytic models manually to avoid multiple service cases from being generated during maintenance of the asset. However, he may sometimes forget to enable the analytic models after the maintenance is completed. This leads to false calculation of Key Performance Indicators (KPIs) associated with asset and thereby resulting in poor throughput. Accordingly, management of portfolio of assets becomes time and cost intensive operation in the facility.

In some instances, there is no visibility of the analytic models that are running on the assets. Also, facility managers may want suggestions around analytic models that are applicable for the assets in the facility, which may be regulated by the facility manager to plan the maintenance of assets in a better way and, thereby, improve the performance of the assets.

Accordingly, there is a need to determine association between the asset and the associated analytic models running on the assets. Further, it becomes essential to control the associated analytic models according to the asset maintenance schedule. Also, there is need to visualize, in a single view, multiple analytic models that are enabled on the assets and provide recommendations for the applicability of the analytic models that are currently not enabled on the assets but may be enabled to improve performance of the assets.

Thus, to address the above challenges, association between an asset and corresponding analytic models are provided by systems and methods described herein. In some instances, data corresponding to the association may be utilized by the service technician or the technical manager to manage the facility. In some embodiments, the data corresponding to the association may be related to action items to manage assets in the facility and to improve overall operational performance of the facility. In some embodiments, the data corresponding to the association may be utilized to control the associated analytic models according to the asset maintenance data. In some embodiments, the data corresponding to the association may be utilized to disable the associated analytic models according to the asset maintenance schedule. For example, disabling the associated analytic models may prevent logging and/or triggering of unwanted service cases during the asset maintenance schedule. This significantly reduces the number of service cases erroneously populated in the list served to the service technician for resolution.

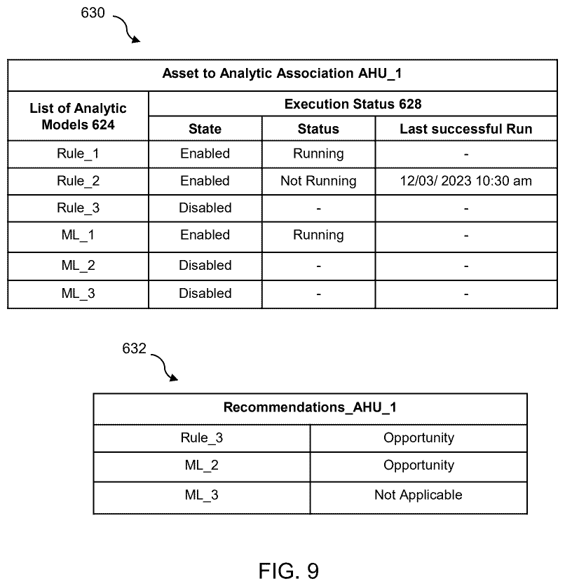

Further, the one or more analytic models that are currently not enabled on the assets, but are available to be enabled, are shown as recommendations. The data corresponding to the association between the asset and the corresponding analytic models, metadata corresponding to the one or more analytic models, and knowledge graph data of the facility may be utilized in generating recommendations related to the applicability of the analytic models on the assets. Further, the recommendations related to the applicability of analytic models on the assets may be utilized by a facility management system to make changes in the facility. For example, the facility management system may utilize the recommendations to change asset settings in the facility. Further, the display of the recommendations provided herein assists in getting insights related to the applicability of analytic models on the assets and results in driving better engagement of personnel to manage the facility. Examples of recommendations are discussed in the description with respect to FIG. 9. Overall, the recommendations improve throughput of the facility. Hence, a holistic view of applicable analytic models corresponding to the assets may aid in improving efficiency of the assets in the facility.

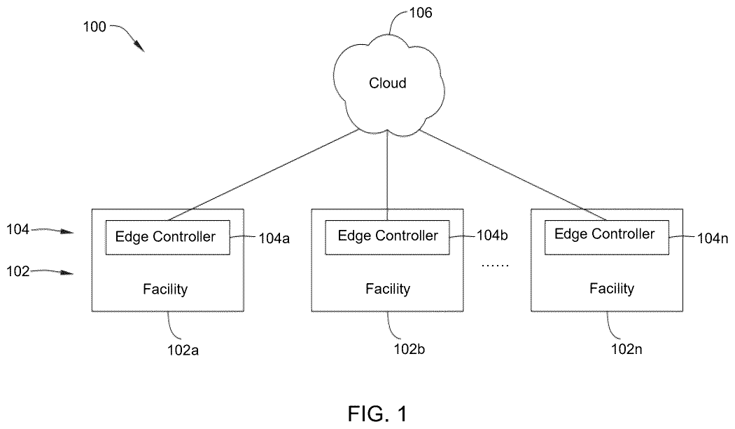

FIG. 1 illustrates a schematic diagram showing a facility management system 100 (hereinafter referred to as “the system 100”) comprising multiple facilities. In an embodiment, the system 100 may be used to facilitate data handling and various operational activities for one or more facilities, such as a first facility 102a, a second facility 102b, . . . nth facility 102n (hereinafter individually and collectively referred to as ‘the facility(ies) 102”). The system 100 may be used to provide multiple analytic models that are applied to an asset of a portfolio of assets to manage the facilities 102. For instance, the system 100 may disable at least one analytic model during a maintenance schedule of the asset to prevent generation of redundant service cases. In some embodiments, the system 100 may provide a holistic view of multiple analytic models that are enabled on each asset. The system 100 may generate a recommendation to enable analytic models corresponding to the asset that are currently not enabled on the asset. Such recommendation may correspond to, for example, a change in configuration of asset settings in the facility 102. In an example, the facility 102 may represent a building or a part of the building. In an embodiment, the facility 102 may include an industrial process or a part of an industrial process. In an embodiment, the facilities 102 may be similar type of establishments. In some embodiments, the facilities 102 may be different establishments, such as an airport, a hospital, a data center, a residential complex, a commercial building, a government building, an institutional building, a monument, an IT park, a corporate office, a tourist place, and the like. As it may be understood, these facilities may include, but not limited to, various electronic equipment and sensor system (referred herein as assets and/or devices) for performing/aiding various operations within the facility 102. In some embodiments, the facility 102 may include multiple sensor systems and sub-systems thereof configured to operate in conjunction to aid one or more operations at the facility. In this regard, these assets may perform several data transactions and exchange large data files in various formats amongst each other using plurality of data communication protocols.

Further, as shown in FIG. 1, a cloud 106 is communicably coupled with each facility 102. The cloud 106 may represent distributed computing resources, software platform or infrastructure services which may enable, but are not limited to, data handling, data processing, data management, and/or analytical operations on the data exchanged & transacted amongst the various assets of the facility 102. In this regard, in an embodiment, operational data, such as the telemetry data (e.g., sensor data) and optionally associated metadata (e.g., contextual information associated with sensor data) may be uploaded to the cloud 106. The operational data may be associated with assets located in the one or more facilities 102. In some embodiments, the cloud 106 may receive and/or transact operational data (OT data) and information technology (IT) enabled data through the facilities 102. In some embodiments, the OT data may represent the telemetry data. The telemetry data may include time stamps and data values thereof. In other words, the telemetry data may represent information collected over a period of time (e.g., continuous data stream captured over a time period) from various assets (e.g., sensors, IoT network) of the facility 102.

Further, the cloud 106 includes one or more servers that may be programmed to communicate with the facilities 102 and to exchange data as appropriate. The cloud 106 may be a single computer server or may include a plurality of computer servers. In an embodiment, the cloud 106 may represent a hierarchal arrangement of two or more computer servers, where perhaps a lower-level computer server (or servers) processes the telemetry data, for example, while a higher-level computer server oversees operation of a lower-level computer server or servers.

Each facility 102 may include a variety of different assets, at least some of which are of same type. Alternatively, each facility 102 may include a variety of different assets, at least some of which are of different type. As shown in FIG. 1, each facility 102 includes a respective edge controller 104a, 104b, . . . 104n (hereinafter individually and collectively referred to as “the edge controller(s) 104”). Each edge controller 104 is configured to receive the telemetry data from a variety of assets within the respective facility 102. In some examples, the telemetry data may represent time-series data and may include a plurality of data values associated with the assets which can be collected over a period of time. For instance, in an example, the telemetry data may represent a plurality of sensor readings collected by a sensor over a period of time. In some embodiments, the edge controllers 104a may operate as intermediary node to transact the telemetry data through one or more assets of the facility 102 and/or to the cloud 106. In some embodiments, each edge controller 104 is capable of receiving the telemetry data from disparate data sources e.g., but not limited to, in different data formats and/or using various data communication protocols, from plurality of assets of the facility 102. In this regard, each edge controller 104 may receive & filter the telemetry data and translate the telemetry data into a common language and/or format (e.g. normalized data) for subsequent communication to the cloud 106. The common language and/or format may be compatible with the cloud 106.

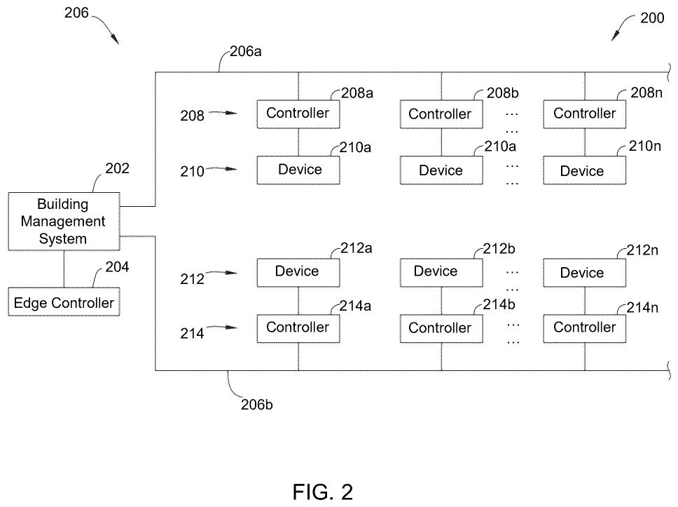

FIG. 2 illustrates a schematic diagram showing a building management system. In various embodiments, an example facility 200 of FIG. 2 includes assets communicatively coupled via multiple networks 206 (e.g. communication channels). Each of the networks 206 may include available and/or known network infrastructure. In an embodiment, each of the networks 206 may independently be, for example, a BACnet® network, a NIAGARA® network, a NIAGARA CLOUD® network, or others. As illustrated in FIG. 2, the facility 200 may include a first network 206a and a second network 206b. Accordingly, a plurality of assets and/or devices are in communication with the building management system 202 via the first network 206a and/or the second network 206b). In some embodiments, each network may represent a sub-network supported by an underlined network communication/IoT protocol and may incorporate a cluster of end-points (e.g. assets, controllers etc. in the facility 200). In an embodiment, the facility 200 may include only a single network 206.

The facility 200 includes a first set of devices 210a, 210b, . . . 210n (hereinafter collectively and individually referred to as “the first device(s) 210”) are operably coupled to the first network 206a via a first set of controllers 208a, 208b, . . . 208n (hereinafter collectively and individually referred to as “the first controller(s) 208”). The first device(s) 210 may represent a variety of assets that may be found within the facility 200. At least some of the first devices 210 are building management system components. Examples of building management system components may be, but are not limited to, sensors, actuators, valves, etc. In one implementation, at least some of the first devices 210 are equipment within a factory. In another implementation, at least some of the first devices 210 are industrial process control devices within an industrial process.

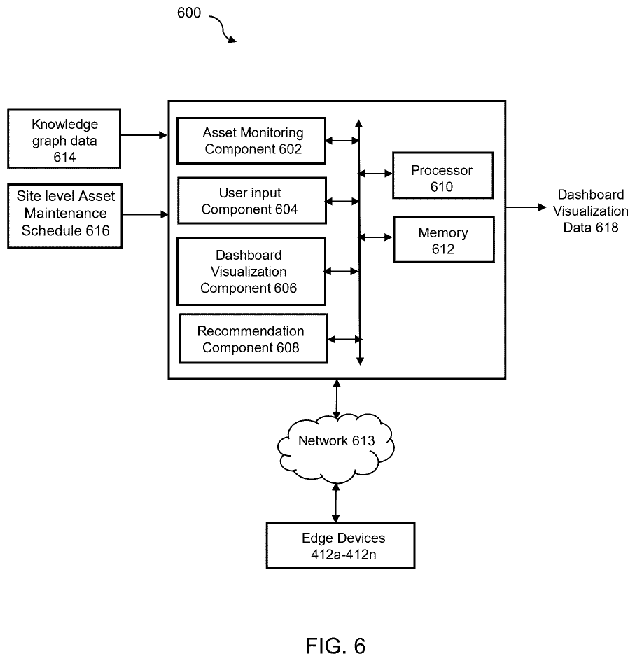

In an embodiment, the first controller 208 controls operation of at least one of the first devices 210. The first controller 208 may transact the telemetry data that may be processed and/or analyzed to determine the analytic models that are enabled for the one or more first devices 210. The telemetry data may represent time-series data and may include a plurality of data values associated with the assets which can be collected over a period of time. For instance, the telemetry data may represent a plurality of sensor readings collected by a sensor over a period of time. The first controller 208 is configured to determine an upcoming maintenance schedule for the one or more first devices 210. The upcoming maintenance schedule may be determined based on user input. In other embodiment, the upcoming maintenance schedule may be determined based on maintenance record stored in a memory (similar to the memory 612 of FIG. 6). Further, the first controller 208 is configured to disable the analytic models during the maintenance schedule for the one or more first devices 210. In an embodiment, the first controller 208 may receive metadata corresponding to the analytic models that may be processed and/or analyzed to generate one or more recommendations for the one or more first devices 210. As described herein, the metadata describe, for example, what a particular data value represents. In one example, the telemetry data may report a value of 68 and a time of 4 pm. The corresponding metadata may identify that the value is a temperature reading of 68 degrees Fahrenheit that was taken at 4 pm. In some examples, metadata can also provide an indication of what an asset is and/or where the asset is located. For example, metadata may indicate that an asset is an air handling unit (AHU) installed on the 3rd floor of a particular building. Further, in some embodiments, the first controller 208 may generate one or more recommendations based on the applicability of the one or more analytic models corresponding to the one or more first devices 210 of the facility 200. In another aspect, the first controller 208 may be built into the first device 210. In another aspect, the first controller 208 may be virtual controllers that may be implemented within a virtual environment hosted by one or more computing devices (not illustrated).

The facility 200 further includes a second set of devices 212a, 212b, . . . 212n (hereinafter collectively and individually referred to as “the second device(s) 212”), are operably coupled to the second network 206b via a second set of controllers 214a, 214b, . . . 214n (hereinafter collectively and individually referred to as “the second controller(s) 214”). The second device(s) 212 may represent a variety of assets within the facility 200. In an aspect, at least some of the second devices 212 are building management system components. Examples of building management system components may be, but are not limited to, sensors, actuators, valves, etc. In one implementation, at least some of the second devices 212 are equipment within a factory. In another implementation, at least some of the second devices 212 are industrial process control devices within an industrial process.

In another embodiment, the second controller 214 control operation of at least one of the second devices 212. The second controller 214 may transact the telemetry data that may be processed and/or analyzed to determine the analytic models that are enabled for the second device 212. The telemetry data may represent time-series data and may include a plurality of data values associated with the assets which can be collected over a period of time. For instance, the telemetry data may represent a plurality of sensor readings collected by a sensor over a period of time. The second controller 214 is configured to determine an upcoming maintenance schedule for the second device 212. The upcoming maintenance schedule may be determined based on user input. In other embodiment, the upcoming maintenance schedule may be determined based on maintenance record stored in a memory (not shown). In some embodiments, the second controller 214 is configured to disable the analytic models during the maintenance schedule for the second device 212. In some embodiments, the second controllers 214 may receive metadata corresponding to the analytic models that may be processed and/or analyzed to generate one or more recommendations for the second device 212. As described herein, the metadata may describe, for example, what a particular data value represents. In one example, the telemetry data may report a value of 68 and a time of 4 pm. The corresponding metadata may identify that the value is a temperature reading of 68 degrees Fahrenheit that was taken at 4 pm. In some examples, metadata can also provide an indication of what an asset is and/or where the asset is located. For example, metadata may indicate that an asset is an air handling unit (AHU) installed on the 3rd floor of a particular building. Further, in some embodiments, the second controller 214 may generate one or more recommendations based on the applicability of the one or more analytic models corresponding to the second device 212 of the facility 200. In another embodiment, the second controller 214 may be built into the second device 212 and may not be a separate component. In another embodiment, the second controller 214 may be a virtual controller that may be implemented within a virtual environment hosted by one or more computing devices (not illustrated).

In an embodiment, the facility 200 may include a Building Management System (BMS) 202 that is communicably coupled with at least one of the first network 206a and the second network 206b.

In an embodiment, an edge controller 204 is installed within the facility 200. In some embodiments, the edge controller 204 may be communicably coupled with the BMS 202. The edge controller 204 may function as an intermediary between the first controllers 208, the second controllers 214, and the cloud 106. In an embodiment, the edge controller 204 may pull data from the first controllers 208 and the second controllers 214 and provide the data to the cloud 106. In an embodiment, the edge controller 204 is configured to identify the first devices 210, the second devices 212, the first controllers 208, and/or the second controllers 214 connected along a local network, such as the network 206. In some cases, the edge controller 204 is configured to identify the first devices 210 and the second devices 212 regardless of an underlaying protocol supported by the first devices 210 and the second devices 212.

In an embodiment, the edge controller 204 may be configured to query the devices found operably coupled to the network 206. Such querying of the devices helps obtaining additional information from the devices to aid the edge controller 204 and/or the cloud 106 to identify the connected devices, such as type of building system components, functionality of the identified building system components, connectivity of the local controllers and/or building system components, types of operational data that is available from the local controllers and/or building system components, types of alarms that are available from the local controllers and/or building system components, and/or any other suitable information. For purpose of brevity, the additional information requested from the devices is referred interchangeably as, ‘metadata’, ‘semantic data’, or ‘model data’, hereinafter throughout the description.

More generally, and in some embodiments, the edge controller 204 may be communicatively coupled to one or more assets, via one or more networks. For purpose of brevity, the term ‘assets’ is also interchangeably referred to as ‘end points’, ‘devices’, ‘sensors’, or ‘electronic devices’ throughout the description. According to various embodiments described herein, the assets may be, for example, but not limited to, sensors, electronic components, pressure valves, HVACs, alarm units, building management systems, building controllers, industrial subsystems, industrial controllers, lightning systems, air detective systems, air quality sensors, etc. These may correspond to, for example, one or more of the first devices 210 and the second devices 212.

According to an embodiment, the edge controller 204 is configured to receive asset data, such as the telemetry data and model data from the one or more assets corresponding to various independent and diverse sub-systems in the facility 200 (e.g., but not limited to, a building, an industrial site, a vehicle, a warehouse etc.). The model data may represent metadata associated with the assets. The model data may be indicative of ancillary or contextual information associated with the asset. For instance, in an example, the model data may be representative of geographical information associated with the asset (e.g. location of the asset) within a facility. In another example, the model data may represent a sensor setting based on which a sensor is commissioned within a facility. In yet another example, the model data may be representative of a data type or a data format associated with the data transacted through the asset. In yet another example, the model data may be indicative of any information which may define a relationship of the asset with one or more other assets in the facility. The one or more assets correspond to various independent and diverse sub-systems in the facility 200. In some embodiments, the telemetry data may represent time-series data and may include a plurality of data values associated with the assets which may be collected over a period of time. For instance, in an embodiment, the telemetry data may represent a plurality of sensor readings collected by a sensor over a period of time. Further, the model data may represent metadata associated with the assets. The model data may be indicative of ancillary or contextual information associated with the asset. For example, the model data may be representative of geographical information associated with the asset (e.g. location of the asset) within the facility 200. In another embodiment, the model data may represent a sensor setting based on which a sensor is commissioned within a facility 200. In yet another embodiment, the model data may be representative of a data type or a data format associated with the data transacted through the asset. In yet another embodiment, the model data may be indicative of any information which may define a relationship between assets in the facility 200. In accordance with various embodiments, the term ‘model data’ may be referred interchangeably as ‘semantic model’ or ‘metadata’ for purpose of brevity.

In accordance with an embodiment, the edge controller 204 is configured to receive the telemetry data and/or the model data in various data formats or different data structures. In an embodiment, a format of the telemetry data and/or the model data, received at the edge controller 204, may be in accordance with a communication protocol of the network that supports transaction of data amongst two or more network nodes (i.e. the edge controller 204 and the asset). As may be appreciated, in some embodiments, the various assets in the facility 200 may be supported by one or more of various network protocols (e.g., IOT protocols like BACnet, Modbus, Lon Works, SNMP, MQTT, Foxs, OPC UA etc.). Accordingly, and in some cases, the edge controller 204 is configured to pull the telemetry data and/or the model data, in accordance with communication protocol supported by the one or more assets.

In some embodiments, the edge controller 204 and/or the cloud 106 may identify one or more anomalies in the facility 200 using the one or more analytic models. One or more anomalies may indicate, for example, one or more problems associated with the one or more assets, such as temperature, power consumption, revenue, status, or other problems associated with the one or more assets. For example, to detect the anomalies, anomaly detection rules may be used. Each rule can be associated with, for example, a set of conditions determined to be indicative of a potential anomaly. The one or more anomalies may be associated with the one or more first devices 210 or the one or more second devices 212 in the facility 200. In some examples, the one or more anomalies may be associated with one or more processes in the facility 200. In some examples, an anomaly may be related to a constant reading in a sensor for a pre-defined time period in the facility 200. In some examples, an anomaly may be related to a mismatch in an operating condition with an operational status of a heating valve in the facility 200. In some examples, an anomaly may be related to a deviation in a supply temperature of water with respect to a predefined threshold temperature value in the facility 200. In some examples, an anomaly may correspond to an overridden fan speed at a variable frequency drive (VFD) panel in the facility 200. In some examples, an anomaly may correspond to a wiring fault in one of a command and feedback cables and/or controller terminals in the facility 200. In some examples, an anomaly may correspond to a mismatch in operational set points with respect to baseline set points of a heating-ventilation, and air-conditioning (HVAC) system in the facility 200.

In an embodiment, the edge controller 204 and/or the cloud 106 may apply one or more analytic models, such as rules, in-house ML algorithms, third party ML algorithms, to address the one or more anomalies in the facility 200. By using one or more analytic models, one or more service cases are identified that indicate the one or more anomalies in the facility 200. In an example, a service case may include instructions to check for a fault in a sensor in the facility 200. In some examples, a service case may comprise instructions to check an operating condition and an operational status of a heating valve in the facility 200. In some examples, a service case may comprise instructions to check for deviation in a supply temperature of water with respect to a predefined threshold in the facility 200. In some examples, a service case may comprise instructions to check the fan speed at the VFD panel in the facility 200. In some examples, a service case may comprise instructions to correct the wiring in the command and feedback cables and/or controller terminals in the facility 200. In some examples, a service case may include instructions to set operational set points of the HVAC system in the facility 200.

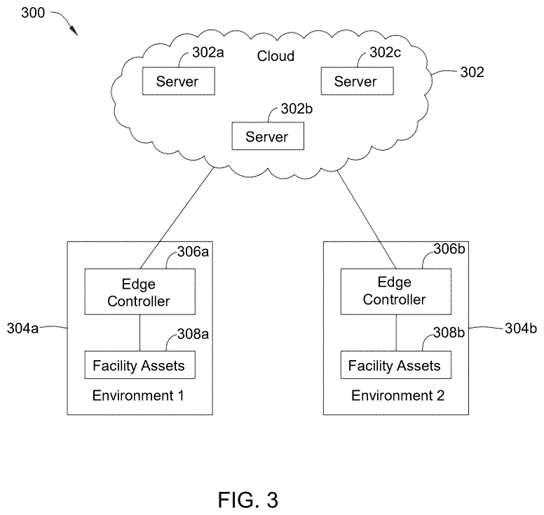

FIG. 3 illustrates a schematic diagram showing a facility management system 300 to manage multiple facilities. In an embodiment, facilities (304a and 304b) may include respective facility assets (308a and 308b) and edge controllers (306a and 306b). In an embodiment, facility assets (308a and 308b) and/or edge controllers (306a and 306b) may be deployed in respective environment 1 and environment 2 of the facilities (304a and 304b). In some embodiments, environment 1 and environment 2 may be similar. In some embodiments, environment 1 and environment 2 may be different. In some embodiments, the facility management system 300 may be configured to receive the telemetry data associated with the facility assets (308a and 308b) and edge controllers (306a and 306b) from the facilities (304a and 304b). The facility management system 300 may use processing resources, such as the edge controllers (306a and 306b) in facilities (304a and 304b) to manage and configure one or more assets (308a and 308b) in the facilities. In an example, the facility management system 300 may use processing resources, such as the edge controllers (306a and 306b) at the facilities (304a and 304b) to manage and configure one or more processes in the facilities (304a and 304b).

In some embodiments, the facility management system 300 may be configured to detect one or more root causes associated with one or more anomalies. In some embodiments, the facility management system 300 may be configured to associate the one or more analytic models with the facility assets (308a and 308b). In some embodiments, the facility management system 300 may be configured to detect one or more root causes based on one or more analytic models such as rules, in-house ML algorithms, third party ML algorithms. In an embodiment, the one or more analytic models may result in one or more service cases to address the one or more root causes and resolve the one or more anomalies in the facilities (304a and 304b). For instance, a service case may include instructions to check for a fault in a sensor in the facilities (304a and 304b). In some embodiments, a service case may comprise instructions to check an operating condition and an operational status of a heating valve in the facilities (304a and 304b). In some embodiments, a service case may comprise instructions to check for deviation in a supply temperature of water with respect to a predefined threshold in the facilities (304a and 304b). In some embodiments, a service case may comprise instructions to check the fan speed at the VFD panel in the facilities (304a and 304b). In some embodiments, a service case may comprise instructions to correct the wiring in the command and feedback cables and/or controller terminals in the facilities (304a and 304b). In some embodiments, a service case may comprise instructions to set operational set points of the HVAC system in the facilities (304a and 304b).

In some embodiments, the facility assets (308a and 308b) in the facilities (304a and 304b) such as a HVAC system, an AHU, a boiler, a sensor, a heating valve, and/or the like require maintenance on a periodic basis to keep working in optimal condition. In an example, some assets require maintenance every month, some assets require maintenance every year and so on. In some embodiments, the maintenance of the facility assets (308a and 308b) may be triggered manually by the service technician in the facilities (304a and 304b). In some embodiments, the maintenance of the facility assets (308a and 308b) may be triggered automatically based on the maintenance schedule of the facility assets (308a and 308b).

In some embodiments, the cloud 302 includes one or more servers 302a, 302b, 302c (hereinafter collectively and individually referred to as “the server(s) 302”).

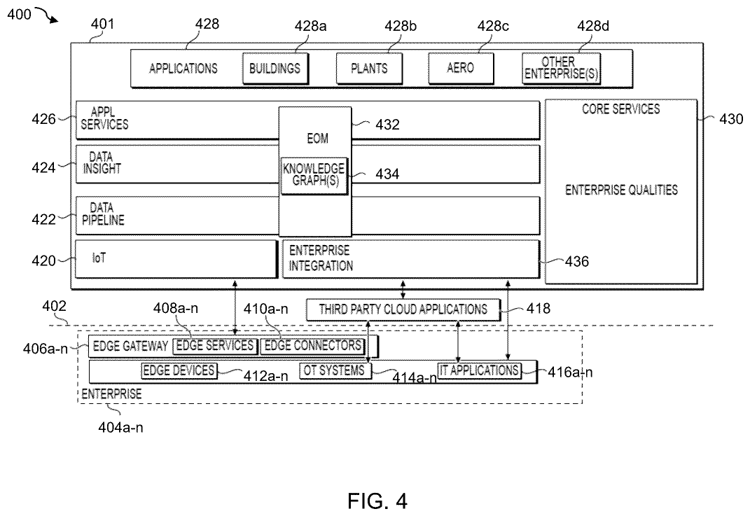

FIG. 4 illustrates a schematic block diagram of framework 400 of an IoT platform 401, according to an aspect of the present disclosure. The IoT platform 401 is provided for facility management that uses real-time models and/or visual analytics to deliver intelligent actions for sustained peak performance of a facility or an enterprise 404. The IoT platform 401 is an extensible platform that may be deployed in any cloud or data center environment for providing an enterprise-wide, top to bottom view, displaying status of processes, assets, people, and safety. Further, the IoT platform 401 supports translating the output into actionable insights and/or intelligent actions, using the framework 400, detailed further below.

As shown in FIG. 4, the framework 400 of the IoT platform 401 comprises a number of layers including, for example, an IoT layer 420, an enterprise integration layer 436, a data pipeline layer 422, a data insight layer 424, an application services layer 426, and an applications layer 428. The IoT platform 401 also includes a core services layer 430 and an extensible object model (EOM) 432 comprising one or more knowledge graphs 434. Each layer 420-430 includes one or more of the modules, models, engines, databases, services, applications, or combinations thereof. In some embodiments, the layers 420-430 are combined to form fewer layers. In some embodiments, some of the layers 420-430 may include sub-layers.

The IoT platform 401 is a model-driven architecture. Accordingly, the EOM 432 is configured to communicate with each layer 420-430 to contextualize site data of the enterprise 404a-404n. In an embodiment, the edge devices 412a-412n may be one of the one or more assets as illustrated in FIGS. 1-3.

As used herein, the EOM 432 is a collection of application programming interfaces (APIs) that enables seeded semantic object models to be extended. For example, the EOM 432 enables the knowledge graph 434 to be built for a customer subject to constraints expressed in the customer's semantic object model. Further, the knowledge graphs 434 are generated by the customers (e.g., enterprises or organizations) to create models of the edge devices 412a-412n of an enterprise 404a-404n, and then, the knowledge graphs 434 are input into the EOM 432 for visualizing the models (e.g., the nodes and links).

The models describe the assets (e.g., the nodes) of an enterprise (e.g., the edge devices 412a-412n) and describe the relationship of the assets with other components (e.g., the links). The models also describe the schema (e.g., describe what the data is), and therefore the models are self-validating. For example, the model describes the type of sensors mounted on any given asset (e.g., edge device 412a-412n) and the type of data that is being sensed by each sensor. According to various embodiments, a key performance indicator (KPI) framework is used to bind properties of the assets in the extensible object model 432. Accordingly, the IoT platform 401 is an extensible, model-driven end-to-end stack including: two-way model sync and secure data exchange between the edge and the cloud, metadata driven data processing (e.g., rules, calculations, and aggregations), and model driven visualizations and applications. As used herein, “extensible” refers to the ability to extend a data model to include new service cases, new rules, new root causes, new resolution codes, new tags, new properties, new columns, new fields, new classes, new tables, and new relations. Thus, the IoT platform 401 is extensible with regards to edge devices 412a-412n and the applications that handle those devices 412a-412n. For example, when new edge devices 412a-412n is added to the enterprise 404a-404n, the new devices 412a-412n will automatically appear in the IoT platform 401 so that the corresponding applications 428 understand and use the data from the new devices 412a-412n to manage the new devices and/or processes in the facility or the enterprise 404a-404n.

In some cases, asset templates are used to facilitate configuration of edge devices 412a-412n. An asset template defines the typical properties for the edge devices 412a-412n of a given facility or enterprise 404a-404n. For example, the asset template of a pump includes modeling the pump having inlet and outlet pressures, speed, flow, etc. The templates may also include hierarchical or derived types of edge devices 412a-412n to accommodate variations of a base type of the device 161a-161n. For example, a reciprocating pump is a specialization of a base pump and would include additional properties in the template. Instances of the edge device 412a-412n in the model are configured to match the actual, physical devices of the enterprise 404a-404n using the templates to define expected attributes of the device 412a-412n. Each attribute is configured either as a static value (e.g., capacity is 1000 BPH) or with a reference to a time series tag that provides the value. The knowledge graph 434 may automatically map the tag to the attribute based on naming conventions, parsing, and matching the tag and attribute descriptions and/or by comparing the behavior of the time series data with expected behavior. In some embodiments, the knowledge graph 434 is configured to utilize the asset template to determine the one or more service cases to address the one or more events in the enterprise 404a-404n.

In some embodiments, modeling phase includes an onboarding process for syncing the models between the edge and the cloud. For example, in one or more embodiments, the onboarding process includes a simple onboarding process, a complex onboarding process, and/or a standardized rollout process. The simple onboarding process includes the knowledge graph 434 receiving raw model data from the edge and running context discovery algorithms to generate the model. The context discovery algorithms read the context of the edge naming conventions of the edge devices 412a-412n and determine what the naming conventions refer to. For example, in one or more embodiments, the knowledge graph 434 receives “TMP” during the modeling phase and determine that “TMP” relates to “temperature.” The generated models are then published. In certain embodiments, the complex onboarding process includes the knowledge graph 434 receiving the raw model data, receiving point history data, and receiving site survey data. According to various embodiments, the knowledge graph 434 then uses these inputs to run the context discovery algorithms. According to various embodiments, the generated models are edited and then the models are published. The standardized rollout process includes manually defining standard models in the cloud and pushing the models to the edge.

The IoT layer 420 includes one or more components for device management, data ingest, and/or command/control of the edge devices 412a-412n. The components of the IoT layer 420 enable data to be ingested into, or otherwise received at, the IoT platform 401 from a variety of sources. For example, in one or more embodiments, data is ingested from the edge devices 412a-412n through process historians or laboratory information management systems. The IoT layer 420 is in communication with the edge connectors 410a-410n installed on the edge gateways 406a-406n through network 402, and the edge connectors 410a-410n send the data securely to the IoT platform 401. In some embodiments, only authorized data is sent to the IoT platform 401, and the IoT platform 401 only accepts data from authorized edge gateways 406a-406n and/or edge devices 412a-412n. According to various embodiments, data is sent from the edge gateways 406a-406n to the IoT platform 401 via direct streaming and/or via batch delivery. Further, after any network or system outage, data transfer will resume once communication is re-established and any data missed during the outage will be backfilled from the source system or from a cache of the IoT platform 401. According to various embodiments, the IoT layer 420 also includes components for accessing time series, alarms and events, and transactional data via a variety of protocols.

The enterprise integration layer 436 includes one or more components for events/messaging, file upload, and/or REST/OData. The components of the enterprise integration layer 436 enable the IoT platform 401 to communicate with third party cloud applications 418, such as any application(s) operated by an enterprise in relation to its edge devices. For example, the enterprise integration layer 436 connects with enterprise databases, such as guest databases, customer databases, financial databases, patient databases, etc. The enterprise integration layer 436 provides a standard application programming interface (API) to third parties for accessing the IoT platform 401. The enterprise integration layer 436 also enables the IoT platform 401 to communicate with the OT systems 414a-414n and IT applications 416a-416n of the enterprise 404a-404n. Thus, the enterprise integration layer 436 enables the IoT platform 401 to receive data from the third-party applications 418 rather than, or in combination with, receiving the data from the edge devices 412a-412n directly. In some embodiments, the enterprise integration layer 436 also enables the IoT platform 401 to receive feedback from one or more users related to the one or more recommendations.

The data pipeline layer 422 includes one or more components for data cleansing/enriching, data transformation, data calculations/aggregations, and/or API for data streams. Accordingly, in one or more embodiments, the data pipeline layer 422 pre-processes and/or performs initial analytics on the received data. The data pipeline layer 422 executes advanced data cleansing routines including, for example, data correction, mass balance reconciliation, data conditioning, component balancing and simulation to ensure the desired information is used as a basis for further processing. The data pipeline layer 422 also provides advanced and fast computation capabilities. In some embodiments, the data pipeline layer 422 may process the feedback to identify new service cases, new rules, new root causes, new resolution codes, new tags, new properties, new columns, new fields, new classes, new tables, and new relations, etc. For example, in one or more embodiments, cleansed data is run through enterprise-specific digital twins. According to various embodiments, the enterprise-specific digital twins include a reliability advisor containing process models to determine the current operation and the fault models to trigger any early detection and determine an appropriate resolution. According to various embodiments, the digital twins also include an optimization advisor that integrates real-time economic data with real-time process data, selects the right feed for a process, and determines optimal process conditions and product yields.

According to various embodiments, the data pipeline layer 422 employs models and templates to define calculations and analytics. Additionally, or alternatively, according to various embodiments, the data pipeline layer 422 employs models and templates to define how the calculations and analytics relate to the one or more assets (e.g., the edge devices 412a-412n). In some embodiments, the data pipeline layer 422 may identify one or more events in the enterprise 404a-404n. For example, in an embodiment, a fan template defines fan efficiency calculations such that every time a fan is configured, the standard efficiency calculation is automatically executed for the fan. The calculation model defines the various types of calculations, the type of engine that should run the calculations, the input and output parameters, the preprocessing requirement and prerequisites, the schedule, etc. According to various embodiments, the actual calculation or analytic logic is defined in the template, or it may be referenced. Thus, according to various embodiments, the calculation model is employed to describe and control the execution of a variety of different process models. According to various embodiments, calculation templates are linked with the asset templates such that when an asset (e.g., edge device 412a-412n) instance is created, any associated calculation instances are also created with their input and output parameters linked to the appropriate attributes of the asset (e.g., edge device 412a-412n). According to various embodiments, the data pipeline layer 422 may identify one or more service cases to address the one or more events in the enterprise 404a-404n.

According to various embodiments, the IoT platform 401 supports a variety of different analytic models including, for example, curve fitting models, regression analysis models, first principles models, empirical models, engineered models, user-defined models, machine learning models, built-in functions, and/or any other types of analytic models. Fault models and predictive maintenance models will now be described by way of example, but any type of models may be applicable.

Fault models are used to compare current and predicted enterprise 404a-404n performance to identify issues or opportunities, and the potential causes or drivers of the issues or opportunities. The IoT platform 401 includes rich hierarchical symptom-fault models to identify abnormal conditions and their potential consequences. For example, in one or more embodiments, the IoT platform 401 drill downs from a high-level condition to understand the contributing factors, as well as determining the potential impact a lower level condition may have. There may be multiple fault models for a given enterprise 404a-404n looking at different aspects such as process, equipment, control, and/or operations. According to various embodiments, each fault model identifies issues and opportunities in their domain, and may also look at the same core problem from a different perspective. According to various embodiments, an overall fault model is layered on top to synthesize the different perspectives from each fault model into an overall assessment of the situation and point to the true root cause.

According to various embodiments, when a fault or opportunity is identified, the IoT platform 401 provides one or more action-based recommendations about optimal corrective actions to take. Initially, the recommendations are based on expert knowledge that has been pre-programmed into the system by process and equipment experts. A recommendation services module presents this information in a consistent way regardless of source, and supports workflows to track, close out, and document the recommendation follow-up. According to various embodiments, the recommendation follow-up is employed to improve the overall knowledge of the system over time as existing recommendations are validated (or not) or new cause and effect relationships are learned by users and/or analytics.

According to various embodiments, the models are used to accurately predict what will occur before it occurs and interpret the status of the installed base. Thus, the IoT platform 401 enables operators to quickly initiate maintenance measures when irregularities occur. In some embodiments, the one or more recommendations may be created to address the irregularities in the enterprise 404a-404n. According to various embodiments, the digital twin architecture of the IoT platform 401 employs a variety of modeling techniques. According to various embodiments, the modeling techniques include, for example, rigorous models, fault detection and diagnostics (FDD), descriptive models, predictive maintenance, prescriptive maintenance, process optimization, and/or any other modeling technique.

According to various embodiments, the rigorous models are converted from process design simulation. In this manner, in certain embodiments, process design is integrated with feed conditions. Process changes and technology improvement provide business opportunities that enable more effective maintenance schedule and deployment of resources in the context of production needs. The fault detection and diagnostics include generalized rule sets that are specified based on industry experience and domain knowledge and may be easily incorporated and used working together with equipment models. According to various embodiments, the descriptive models identify a problem, and the predictive models determines possible damage levels and maintenance options. According to various embodiments, the descriptive models include models for defining the operating windows for the edge devices 412a-412n.

Predictive maintenance includes predictive analytics models developed based on rigorous models and statistic models, such as, for example, principal component analysis (PCA) and partial least square (PLS). According to various embodiments, machine learning methods are applied to train models for fault prediction. According to various embodiments, predictive maintenance leverages FDD-based algorithms to continuously monitor individual control and equipment performance. Predictive modeling is then applied to a selected condition indicator that deteriorates in time. Prescriptive maintenance includes determining an optimal maintenance option and when it should be performed based on actual conditions rather than time-based maintenance schedule. According to various embodiments, prescriptive analysis selects the right solution based on the company's capital, operational, and/or other requirements. Process optimization is determining optimal conditions via adjusting set-points and schedules. The optimized set-points and schedules may be communicated directly to the underlying controllers, which enables automated closing of the loop from analytics to control.

The data insight layer 424 includes one or more components for time series databases (TDSB), relational/document databases, data lakes, blob, files, images, and videos, and/or an API for data query. According to various embodiments, when raw data is received at the IoT platform 401, the raw data is stored as time series tags or events in warm storage (e.g., in a TSDB) to support interactive queries and to cold storage for archive purposes. According to various embodiments, the raw data may comprise tagged information provided by a user or a worker via a user interface. According to various embodiments, data is sent to the data lakes for offline analytics development. According to various embodiments, the data pipeline layer 422 accesses the data stored in the databases of the data insight layer 424 to perform analytics, as detailed above.

The application services layer 426 includes one or more components for rules engines, workflow/notifications, KPI framework, insights (e.g., actionable insights), decisions, recommendations, machine learning, and/or an API for application services. The application services layer 426 enables building of applications 428a-d. The applications layer 428 includes one or more applications 428a-d of the IoT platform 401. For example, according to various embodiments, the applications 428a-d includes a buildings application 428a, a plants application 428b, an aero application 428c, and other enterprise applications 428d. According to various embodiments, the applications 428 includes general applications for portfolio management, asset management, autonomous control, and/or any other custom applications. According to various embodiments, portfolio management includes the KPI framework and a flexible user interface (UI) builder. According to various embodiments, asset management includes asset performance, asset health, and/or asset predictive maintenance. According to various embodiments, autonomous control includes energy optimization and/or predictive maintenance. As detailed above, according to various embodiments, the general applications 428a-d is extensible such that each application 428a-d is configurable for the different types of enterprises 404a-404n (e.g., buildings application 428a, plants application 428b, aero application 428c, and other enterprise applications 428d).

The applications layer 428 also enables visualization of performance of the enterprise 404a-404n. For example, dashboards provide a high-level overview with drill downs to support deeper investigations. In one or more embodiments, the dashboards provide one or more service cases to address the one or more events in the enterprise 404a-404n. Recommendation summaries give users prioritized actions to address current or potential issues and opportunities. Data analysis tools support ad hoc data exploration to assist in troubleshooting and process improvement. In one or more embodiments, the dashboards may represent a ranking of one or more users or worker.

The core services layer 430 includes one or more services of the IoT platform 401. According to various embodiments, the core services 430 include data visualization, data analytics tools, security, scaling, and monitoring. According to various embodiments, the core services 430 also include services for tenant provisioning, single login/common portal, self-service admin, UI library/UI tiles, identity/access/entitlements, logging/monitoring, usage metering, API gateway/dev portal, and the IoT platform 401 streams.

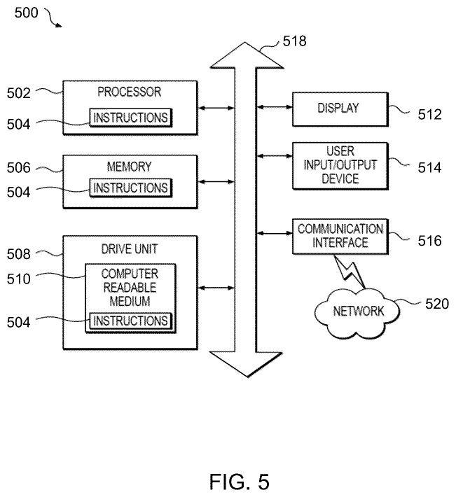

FIG. 5 depicts an implementation of a controller 500 that may execute techniques presented herein, according to one or more embodiments. The controller 500 may include a set of instructions that may be executed to cause the controller 500 to perform any one or more of the methods or computer based functions disclosed herein. The controller 500 may operate as a standalone device or may be connected, e.g., using a network, to other computer systems or peripheral devices.

As illustrated in FIG. 5, the controller 500 may include a processor 502, e.g., a central processing unit (CPU), a graphics processing unit (GPU), or both. The processor 502 may be a component in a variety of systems. For example, the processor 502 may be part of a standard computer. The processor 502 may be one or more general processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e., programmed).

The controller 500 may include a memory 506 that may communicate via a bus 518. The memory 506 may be a main memory, a static memory, or a dynamic memory. The memory 506 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 506 includes a cache or random-access memory for the processor 502. In alternative implementations, the memory 506 is separate from the processor 502, such as a cache memory of a processor, the system memory, or other memory. The memory 506 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 506 is operable to store instructions executable by the processor 502. The functions, acts or tasks illustrated in the FIG.s or described herein may be performed by the processor 502 executing the instructions stored in the memory 506. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 500 may further include a display 512, such as a liquid crystal display (LCD), an organic light emitting diode (OLED), a flat panel display, a solid-state display, a cathode ray tube (CRT), a projector, a printer or other now known or later developed display device for outputting determined information. The display 512 may act as an interface for the user to see the functioning of the processor 502, or specifically as an interface with the software stored in the memory 506 or in the drive unit 508.

Additionally or alternatively, the controller 500 may include an input/output device 514 configured to allow a user to interact with any of the components of controller 500. The input/output device 514 may be a number pad, a keyboard, or a cursor control device, such as a mouse, or a joystick, touch screen display, remote control, or any other device operative to interact with the controller 500.

The controller 500 may also or alternatively include drive unit 508 implemented as a disk or optical drive. The drive unit 508 may include a computer-readable medium 510 in which one or more sets of instructions 504, e.g. software, may be embedded. Further, the instructions 504 may embody one or more of the methods or logic as described herein. The instructions 504 may reside completely or partially within the memory 506 and/or within the processor 502 during execution by the controller 500. The memory 506 and the processor 502 also may include computer-readable media as discussed above.

In some systems, a computer-readable medium 510 includes instructions 504 or receives and executes instructions 504 responsive to a propagated signal so that a device connected to a network 520 may communicate voice, video, audio, images, or any other data over the network 520. Further, the instructions 504 may be transmitted or received over the network 520 via a communication port or interface 516, and/or using a bus 518. The communication port or interface 516 may be a part of the processor 502 or may be a separate component. The communication port or interface 516 may be created in software or may be a physical connection in hardware. The communication port or interface 516 may be configured to connect with a network 520, external media, the display 512, or any other components in controller 500, or combinations thereof. The connection with the network 520 may be a physical connection, such as a wired Ethernet connection or may be established wirelessly as discussed below. Likewise, the additional connections with other components of the controller 500 may be physical connections or may be established wirelessly. The network 520 may alternatively be directly connected to a bus 518.

While the computer-readable medium 510 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 510 may be non-transitory, and may be tangible.

In an alternative implementation, dedicated hardware implementations, such as application specific integrated circuits, programmable logic arrays and other hardware devices, may be constructed to implement one or more of the methods described herein. Applications that may include the apparatus and systems of various implementations may broadly include a variety of electronic and computer systems. One or more implementations described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

The controller 500 may be connected to a network 520. The network 520 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 520 may include wide area networks (WAN), such as the Internet, local area networks (LAN), campus area networks, metropolitan area networks, a direct connection such as through a Universal Serial Bus (USB) port, or any other networks that may allow for data communication. The network 520 may be configured to couple one computing device to another computing device to enable communication of data between the devices. The network 520 may generally be enabled to employ any form of machine-readable media for communicating information from one device to another. The network 520 may include communication methods by which information may travel between computing devices. The network 520 may be divided into sub-networks. The sub-networks may allow access to all of the other components connected thereto or the sub-networks may restrict access between the components. The network 520 may be regarded as a public or private network connection and may include, for example, a virtual private network or an encryption or other security mechanism employed over the public Internet, or the like. In accordance with various implementations of the present disclosure, the methods described herein may be implemented by software programs executable by a computer system. Further, in an exemplary, non-limited implementation, implementations may include distributed processing, component/object distributed processing, and parallel processing. Alternatively, virtual computer system processing may be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

FIG. 6 is an exemplary block diagram illustrating an implementation of a service case management system 600 in the facility 102. The service case management system 600 may be used for management of service cases in the facility 102. In this regard, a service case may correspond to a work task, a work ticket raised to resolve an issue or an action item which may be tracked at various stages of its execution for resolution of an issue in the facility 102. In some embodiments, the service cases may be generated during a maintenance operation of the assets (e.g. HVAC unit, lighting system, air purification system, etc.) in the facility 102. Asset maintenance operation includes a set of activities aimed at ensuring that the equipment, machinery, and other facility assets function in their optimal condition through scheduled repairs and servicing. In some embodiments, the service case management system 600 may receive data from various data sources. For instance, the service case management system 600 may receive data, for example, but not limited to, (a) asset data 622 from edge devices 412a-412n, (b) the knowledge graph data 614 of the facility, (c) real-time input feed from a field technician, such as maintenance schedule 616 of the assets in the facility, (d) metadata corresponding to one or more analytic models 624, etc. The service case management system 600 may process the data received from various data sources. The service case management system 600 may be configured to receive asset data 622 from the edge devices 412a-412n associated with the facility 102. In an embodiment, the edge devices 412a-412n may include databases, assets (e.g., building assets, industrial assets, etc.), IoT devices (e.g., industrial IoT devices), connected building assets, sensors, actuators, processors, computers, valves, pumps (e.g., centrifugal pumps, etc.), motors, compressors, turbines, ducts, heaters, chillers, coolers, boilers, furnaces, heat exchangers, fans, blowers, conveyor belts, vehicle components, cameras, displays, security components, air handler units, HVAC components, industrial equipment, factory equipment, and/or other devices that are connected to the network 613 for collecting, sending, and/or receiving information. In some embodiments, the edge device 412a-412n include, or is otherwise in communication with, one or more controllers for selectively controlling a respective edge device 412a-412n and/or for sending/receiving information between the edge devices 412a-412n and the service case management system 600. The asset data 622 includes, for example, connected building data, sensor data, real-time data, live property value data, asset heath data, event data, process data, operational data, fault data, location data, and/or other data associated with the edge devices 412a-412n. The asset health data may include values of age of the asset, service history of the asset, etc. The knowledge graph data 614 includes equipment details, equipment properties, relation of the equipment with other assets, relation of equipment with spaces in the facility 102. In an aspect, the knowledge graph may include the knowledge graphs 434 illustrated in FIG. 4. The knowledge graphs 434 define a collection of nodes and links that describe real-world connections that enable smart systems. As used herein, a knowledge graph 434: (i) describes real-world entities (e.g., edge devices 412a-412n) and their interrelations organized in a graphical interface; (ii) defines possible classes and relations of entities in a schema; (iii) enables interrelating arbitrary entities with each other; and (iv) covers various topical domains. In other words, the knowledge graphs 434 define large networks of entities (e.g., edge devices 412a-412n), semantic types of the entities, properties of the entities, and relationships between the entities. Thus, the knowledge graphs 434 describe a network of “things” that are relevant to a specific domain, an enterprise, or a facility. Knowledge graphs 434 are not limited to abstract concepts and relations, but may also contain instances of objects, such as, for example, documents and datasets. The metadata corresponding to one or more analytic models 624 includes, but not limited to Name of the analytics, version of the analytics, schema for the analytics, etc.

In an embodiment, the service case management system 600 is a server system (e.g., a server device) that facilitates a data analytics platform between one or more computing devices, one or more data sources, and/or one or more assets. The service case management system 600 is a device with one or more processors 610 and a memory 612. For example, in one or more embodiments, the service case management system 600 is implemented via the cloud 106. The service case management system 600 is also related to one or more technologies, such as, for example, enterprise technologies, connected building technologies, industrial technologies, Internet of Things (IoT) technologies, data analytics technologies, digital transformation technologies, cloud computing technologies, cloud database technologies, server technologies, network technologies, private enterprise network technologies, wireless communication technologies, machine learning technologies, artificial intelligence technologies, digital processing technologies, electronic device technologies, computer technologies, supply chain analytics technologies, aircraft technologies, industrial technologies, cybersecurity technologies, navigation technologies, asset visualization technologies, oil and gas technologies, petrochemical technologies, refinery technologies, process plant technologies, procurement technologies, and/or one or more other technologies.

The service case management system 600 may comprise one or more components such as, an asset monitoring component 602, a user input component 604, a dashboard visualization component 606 and/or a recommendation component 608. Additionally, in one or more embodiments, the service case management system 600 includes a processor 610 and/or a memory 612. One or more aspects of the service case management system 600 (and/or other systems, apparatuses and/or processes disclosed herein) constitute executable instructions embodied within a computer-readable storage medium (e.g., the memory 612). For instance, the memory 612 stores computer executable component and/or executable instructions (e.g., program instructions). Furthermore, the processor 610 facilitates execution of the computer executable components and/or the executable instructions (e.g., the program instructions). The processor 610 is configured to execute instructions stored in memory 612 or otherwise accessible to the processor 610.

The processor 610 is a hardware entity (e.g., physically embodied in circuitry) capable of performing operations according to one or more embodiments of the disclosure. Alternatively, in an embodiment where the processor 610 is embodied as an executor of software instructions, the software instructions configure the processor 610 to perform one or more algorithms and/or operations described herein in response to the software instructions being executed. In an embodiment, the processor 610 is a single core processor, a multi-core processor, multiple processors internal to the service case management system 600, a remote processor (e.g., a processor implemented on a server), and/or a virtual machine. In certain embodiments, the processor 610 is in communication with the memory 612, the asset monitoring component 602, the user input component 604, the dashboard visualization component 606, the recommendation component 608, via a bus to, for example, facilitate transmission of data among the processor 610, the memory 612, the asset monitoring component 602, the user input component 604, the dashboard visualization component 606, and the recommendation component 608. The processor 610 may be embodied in a number of different ways and, in certain embodiments, includes one or more processing devices configured to perform independently. Additionally, or alternatively, the processor 610 includes one or more processors configured in tandem via a bus to enable independent execution of instructions, pipelining of data, and/or multi-thread execution of instructions.

The memory 612 is non-transitory and includes, for example, one or more volatile memories and/or one or more non-volatile memories. In other words, in one or more embodiments, the memory 612 is an electronic storage device (e.g., a computer-readable storage medium). The memory 612 is configured to store information, data, content, one or more applications, one or more instructions, or the like, to enable the service case management system 600 to carry out various functions in accordance with one or more embodiments disclosed herein. In accordance with some embodiments described herein, the memory 612 may correspond to an internal or external memory of the service case management system 600. In some embodiments, the memory 612 may correspond to a database communicatively coupled to the service case management system 600. As used herein in this disclosure, the term “component,” “system,” and the like, is a computer-related entity. For instance, “a component,” “a system,” and the like disclosed herein is either hardware, software, or a combination of hardware and software. As an example, a component is, but is not limited to, a process executed on a processor, a processor circuitry, an executable component, a thread of instructions, a program, and/or a computer entity.

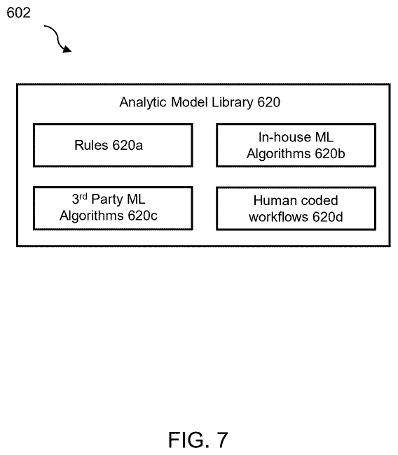

The asset monitoring system 602 may be configured to monitor the assets in one or more facilities. In one or more embodiments, the asset monitoring system 602 may be configured to process the asset data 622, such as operational data, and/or the telemetry data, received from the edge devices 412a-412n. The asset monitoring system 602 may comprise an analytic model library 620. As illustrated in FIG. 7, the analytic model library 620 may include one or more analytic models 624, such as one or more rules 620a, one or more in-house machine learning (ML) algorithms 620b, one or more third party ML algorithms 620c, and one or more human coded workflows 620d. The one or more analytic models 624 are registered into the analytic model library 620. An analytic model is designed to process a specific set of data inputs in order to generate an output. The analytic model library 620 may store the metadata corresponding to one or more analytic models 624, such as Name of the analytics, version of the analytics, schema for the analytics. The schema may include information about type of assets, specific points required on the assets to run a particular analytic model on these assets, as detailed below. The processor 610 determines the one or more analytic models that are enabled on the assets based on processing of the asset data 622. The processor 610 detects one or more service cases in one or more facilities based on the one or more analytic models enabled corresponding to the one or more assets.

The service case management system 600 (e.g., the user input component 604 of the service case management system 600) receives one or more inputs from a user or a worker or a service technician via a user interface of a computing device (not shown). The one or more inputs are associated with the one or more assets in the facility. In one or more embodiments, the one or more inputs are associated with the asset maintenance schedule 616. The one or more inputs may be provided by the user while resolving at least one service case rendered as a dashboard. The processor 610 determines an upcoming maintenance schedule of the assets based on the user input. The processor 610 determines an upcoming maintenance schedule of the one or more assets automatically based on maintenance record stored in the memory 612. During maintenance of the one or more assets, different operational procedures are performed corresponding to the one or more assets by the service technician. Due to these operational procedures, there may be some variations in the processing of the telemetry data or there may be some variations in certain thresholds or setpoints. As a result, when the maintenance of the one or more assets is triggered, multiple service cases are generated. Accordingly, the processor 610 disables the one or more analytic models during the asset maintenance operation to avoid accumulation of the service cases in a user's worklog that needs attention. In one or more embodiments, the processor 610 is configured to re-enable the one or more analytic models after completion of the asset maintenance operation. The processor 610 may disable in-house analytic models such as rules, ML algorithms, etc. during the maintenance schedule of the assets. In another embodiment, the processor 610 may disable third party analytic models during entire maintenance period using explicit API interface/mechanism provided by the third party. In one or more embodiments, the processor 610 determines one or more third-party analytic models from among the one or more analytic models that cannot be disabled during the maintenance schedule of the one or more assets. These third-party analytic models would keep running on the one or more assets. One reason could be certain complexities in disabling/stopping these third party analytic models. For example, there may not be any explicit API interface/mechanism provided from the third party to disable the analytic models. Further, during maintenance schedule, insights related to the assets (e.g., performance of the assets, health of the assets, efficiency of the assets, etc.) are pulled at a specific frequency, say, every 30 minutes from third party analytic models which might get translated into service cases if there is an anomaly. This leads to generation of one or more unwanted service cases corresponding to the third party analytic models during the maintenance schedule of the one or more assets. As a result, the processor 610 identifies the maintenance schedule of the assets and excludes pulling insights during the maintenance schedule. In another embodiment, the processor 601 may automatically reject the service cases generated corresponding to the third party analytic models during the maintenance schedule. This avoids the accumulation of service cases during the maintenance schedule of the asset. In another embodiment, the processor 610 filters or highlights the one or more service cases. For example, the processor 610 generates flag for the asset KPIs that are generated corresponding to the third-party analytic models during the maintenance schedule of the one or more assets. The generated flag is displayed on an electronic interface of a computing device (not shown) and assists the service technician to visually distinguish the service cases that are generated during the maintenance schedule of the one or more assets. This helps in saving time and effort of the service technician.

According to some embodiments, the dashboard visualization component 606 generates dashboard visualization data 618. The dashboard visualization data 618 may be displayed at a site level or a portfolio level. In one or more embodiments, the dashboard visualization component 606 provides the dashboard visualization data 618 to the electronic interface of the computing device. In one or embodiments, the data visualization component 606 renders visualization of multiple analytic models that are enabled or disabled corresponding to a particular asset in a single view. In one or more embodiments, the dashboard visualization data 618 includes, but not limited to, one or more assets in the facility and asset data 622 associated with the one or more assets. In one or more embodiments, the dashboard visualization data 618 further includes, but is not limited to, list of analytic models 624 that are available in the facility, asset maintenance data 626 including asset maintenance schedule of the one or more assets, the execution status 628 of one or more analytic models, asset to analytic association 630 that indicates the one or more analytic models enabled corresponding to each asset of the one or more assets, and one or more recommendations 632 indicating applicability of the one or more analytic models corresponding to the one or more assets, as illustrated in FIG. 9. The dashboard visualization component 606 ensures complete visibility of the multiple types of data in the single view. Further, the dashboard visualization component 606 enables holistic view of the one or more analytic models that are enabled for each asset in the facility. In one or more embodiments, the dashboard visualization component 606 generates a user-interactive electronic interface that renders a visual representation of data in the single view.

According to some embodiments, the recommendation component 608 may be configured to generate one or more recommendations related to the applicability of a particular analytic model corresponding to the asset based on the knowledge graph data 614 of the facility. In an embodiment, the recommendation component 608 is configured to receive metadata corresponding to each of a plurality of analytic models that is not enabled corresponding to an asset. The metadata defines a type of the analytic model. The metadata includes, but is not limited to, name of the analytics, version of the analytics, schema for the analytics, etc. The schema may include information about type of assets, specific data points required on the assets to run a particular analytic model on these assets. In an embodiment, a particular rule works on a particular asset and corresponding set of data points. For example, a rule that compares current value of temperature with a target value of temperature is required for temperature control in HVAC applications. In a similar manner, a particular machine learning algorithm, such as chiller analytics works on a specific chiller and corresponding set of data points. Because of schema of a particular analytic model, a set of data points may be identified corresponding to the asset that are required such that the particular analytic model may run on the asset. This helps to generate recommendations related to the applicability of a particular analytic model corresponding to the asset. Based on the stored metadata and the knowledge graph data 614, the processor 610 identifies the one or more analytic models in the analytic model library 620 that may be applied to the one or more assets. Further, the processor 610 determines the multiple analytic models that are already enabled on the assets based on the asset data 622, as described above. As a result, the one or more analytic models that are currently not enabled on the assets, but are available to be enabled, are shown as recommendations. For example, an analytic model AM_1 in the analytic model library 620 may run on chillers for chiller optimization. Let's assume there are two chillers CH_1 and CH_2 in the facility having some data points. Based on the data points of the chillers, the analytic model AM_1 is already enabled on the first chiller CH_1 and not on second chiller CH_2. Therefore, the analytic model AM_1 is provided as recommendation corresponding to the chiller CH 2. Let's consider another example, there is an analytic model AM_2 in the analytic model library 620 that may run on AHUs for AHU optimization. Let's assume there are 10 AHUs in the facility out of which 8 AHUs have required data points to enable the analytic model AM_2. The analytic model AM_2 is already enabled on 2 AHUs. Therefore, the analytic model AM_2 may be provided as recommendation corresponding to the remaining 6 AHUs on the dashboard to enable the analytic model AM_2 corresponding to 6 AHUs. The one or more anomalies could be identified in an efficient manner by enabling the recommended analytic models on the assets. This facilitates efficient management of portfolio of assets in the facility. In some embodiments, the one or more recommendations may be one or more specific actions that the service technician has to undertake in the facility.

FIG. 7 illustrates an exemplary block diagram showing an implementation of the asset monitoring component 602. In an embodiment, the analytic model library 620 includes the one or more rules 620a that may be generated by a rule engine. The one or more rules may define threshold values for one or more parameters associated with assets and/or sensors in the facility. In this regard, the one or more parameters may be, but are not limited to, temperature, operational status, duration of operation, voltage, current, flow rate, etc. For example, a rule may include instructions to check if zone temperature of Fan Powered Boxes (FPB) is more than setpoint by 3.7° F. In another embodiment, a rule may be directed to check operational status of an asset for a pre-determined time. In this regard, the rule may include checking if a reheat valve is closed or open for every 20 minutes. Further, in some embodiments, the rule may include checking if air handling unit (AHU) discharge temperature satisfies a pre-defined threshold for a pre-determined time. One or more rules described herein are exemplary only and are not limited to embodiments described herein.

The analytic model library 620 includes the one or more in-house ML algorithms 620b and the one or more third party ML algorithms 620c. In some exemplary embodiments, the facility management system 100 includes model building tools that allow the user to create custom analytic models for inclusion in the service case management system 600. In general, the machine learning algorithms may be trained algorithms designed to analyze specified data inputs to perform such functions as generating predictions regarding operation of an industrial machine or process (e.g., predicting product output, a time-to-failure for a device or machine, energy consumption, machine emissions, etc.), identifying a modification to an industrial process or control parameter that may optimize a performance metric of a controlled industrial asset, calculate statistics regarding operation of an industrial machine or process, or other such analytic functions. The third party ML algorithms 620c, for example, are algorithms executed by external applications (e.g., third-party applications that offer analytic models that may be applied to end user data) that are developed in a separate development system. In this way, the analytic model library 620 includes locally stored in-house ML algorithms 620b, or analytic models that are developed by external systems, such as third party ML algorithms 620c. The one or more in-house ML algorithms 620b may be, for example, sound analytics, vibration analytics, etc.

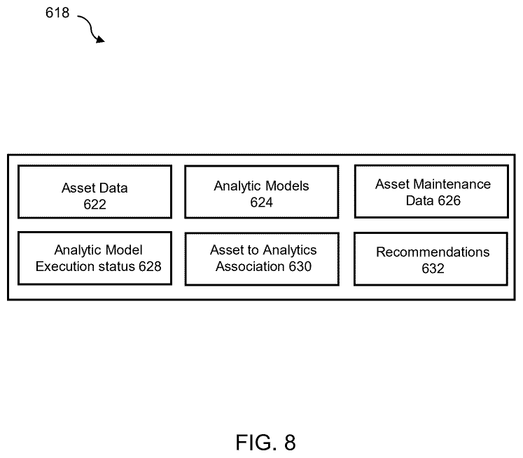

FIG. 8 illustrates an exemplary illustration of dashboard visualization data, in accordance with an aspect of the present disclosure. The dashboard visualization data 618 includes, but not limited to, the asset data 622, list of analytic models 624, asset maintenance data 626, the execution status 628 of one or more analytic models, asset to analytic association 630, and one or more recommendations 632. The asset data 622 associated with one or more assets in the facility is displayed on the dashboard. The asset data 622 includes, for example, connected building data, sensor data, real-time data, live property value data, event data, process data, operational data, fault data, location data, and/or other data associated with the edge devices 412a-412n. The list of analytic models 624 that are available in the facility is displayed on the dashboard. The list of analytic models 624 includes one or more rules 620a, one or more in-house machine learning (ML) algorithms 620b, one or more third party ML algorithms 620c, and one or more human coded workflows 620d. Referring to FIG. 9, the list of analytic models 624 indicating Rule_1, Rule_2, Rule_3, ML_1, ML_2, ML_3 is displayed corresponding to AHU_1. The asset maintenance data 626 including upcoming maintenance schedule of the one or more assets is displayed on the dashboard. The asset maintenance schedule may either be triggered manually by the service technician or triggered automatically based on the maintenance record. Further, the maintenance schedule may be downloaded from the server 302a (or 302b or 302c). The maintenance schedule could be downloaded or imported at regular intervals. The execution status 628 of one or more analytic models is displayed on the dashboard. For example, few rules may be configured to run every hour depending on associated complexity. Few ML algorithms may be configured to run daily. The execution status 628 includes the current state of the analytic model corresponding to the particular asset, such as AHU_1. The current state may be enabled or disabled. The current state of the each of the plurality of analytic models is updated in real-time. The status includes whether the particular analytic model, such as Rule_1, Rule_2, Rule_3, ML_1, ML_2, ML_3, is running corresponding to the particular asset, such as AHU_1, in real time. Further, the last successful run of the particular analytic model includes history of last successful run, such as date and/or time, as shown in FIG. 9. The asset to analytic association 630 indicating the one or more analytic models enabled corresponding to each asset is displayed on the dashboard. As illustrated in FIG. 9, Rule_1, Rule_2, and ML_1 are enabled corresponding to the asset AHU_1. The one or more recommendations 632 indicating applicability of the one or more analytic models corresponding to the particular asset. For example, for a particular asset, such as a chiller, 30 rules are applicable corresponding to the chiller. However, only 15 rules may be enabled on the chiller. Remaining 15 rules, which are eligible to be enabled, may be provided as recommendations based on the data points of the chiller. As illustrated in FIG. 9, the analytic models Rule_3 and ML_2 are currently disabled corresponding to the AHU_1 but may be enabled based on the data points of the chiller. The analytic models Rule_3 and ML_2 are indicated as “opportunity”. However, the analytic model ML_3 is indicated as “Not Applicable”.

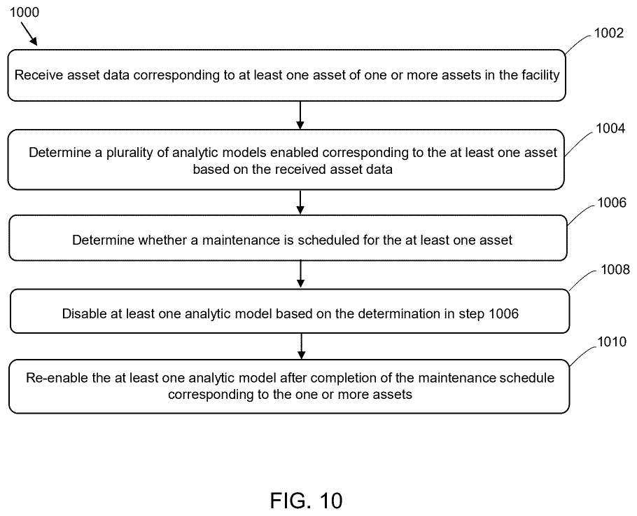

FIG. 10 illustrates a flowchart showing a method described in accordance with some embodiments described herein. At step 1002, the service case management system 600 includes the processor 610 configured to receive the asset data 622 corresponding to at least one asset of the one or more assets in the facility. At step 1004, the processor 610 is configured to determine a plurality of analytic models that are enabled corresponding to the at least one asset of the one or more assets based on the received asset data. At step 1006, the processor 610 is configured to determine that the maintenance is scheduled for the at least one asset based on the user input or the stored maintenance record of the one or more assets. At step 1008, the processor 610 is configured to disable at least one analytic model based on the determination at step 1006. This step ensures that the unwanted service cases are not triggered during the asset maintenance. At step 1010, the processor 610 is configured to re-enable the at least one analytic model after completion of the maintenance schedule corresponding to the one or more assets.

Many modifications and other embodiments of the inventions set forth herein will come to mind to one skilled in the art to which these inventions pertain having the benefit of teachings presented in the foregoing descriptions and the associated drawings. Although the FIG.s only show certain components of the apparatus and systems described herein, it is understood that various other components may be used in conjunction with the supply management system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

1. A system, comprising:
a memory; and
a processor coupled to the memory, the processor configured to:
receive asset data corresponding to at least one asset of a plurality of assets;
determine a plurality of analytic models that are enabled corresponding to the at least one asset based on the received asset data;
determine that a maintenance is scheduled for the at least one asset;
disable at least one analytic model from the plurality of analytic models during the schedule for the maintenance of the at least one asset;
re-enable the at least one analytic model after completion of the schedule for the maintenance of the at least one asset; and
render visualization of execution status of each of the plurality of analytic models corresponding to the at least one asset on a display device.

2. The system of claim 1, wherein the processor is further configured to receive knowledge graph data of a facility.

3. The system of claim 1, wherein the plurality of analytic models comprises at least one of a rule-based model, a machine learning model, and a human-coded workflow.

4. The system of claim 1, wherein the schedule for maintenance of the at least one asset is determined based on at least one of a maintenance record or a user input.

5. The system of claim 1, wherein the asset data comprises at least one of an asset type, operational data, and telemetry data.

6. The system of claim 1, wherein the processor is further configured to render visualization of the plurality of analytic models corresponding to the at least one asset in a single view on the display device.

7. The system of claim 2, wherein the processor is further configured to:
receive metadata corresponding to a plurality of analytic models that are not enabled corresponding to the at least one asset; and
generate, based on the metadata and the knowledge graph data, a recommendation indicating applicability of at least one analytic model of the plurality of analytic models that are not enabled corresponding to the at least one asset.

8. The system of claim 7, wherein the processor is further configured to control display of the generated recommendation on the display device.

9. The system of claim 1, wherein the processor is further configured to determine at least one third party analytic model from among the plurality of analytic models, wherein the at least one third party analytic model is not disabled during the schedule for the maintenance of the at least one asset.

10. The system of claim 9, wherein the processor is further configured to filter a plurality of service cases generated corresponding to the at least one third party analytic model during the schedule for the maintenance of the at least one asset.

11. The system of claim 9, wherein the processor is further configured to highlight a plurality of service cases generated corresponding to the at least one third party analytic model during the schedule for the maintenance of the at least one asset.

12. A method, comprising:
receiving asset data corresponding to at least one asset of a plurality of assets;
determining a plurality of analytic models that are enabled corresponding to the at least one asset based on the received asset data;
determining that a maintenance is scheduled for the at least one asset;
disabling at least one analytic model from the plurality of analytic models during the schedule for the maintenance of the at least one asset;
re-enabling the at least one analytic model after completion of the schedule for the maintenance of the at least one asset; and
rendering visualization of execution status of each of the plurality of analytic models corresponding to the at least one asset on a display device.

13. The method of claim 12, further comprising receiving knowledge graph data of a facility.

14. The method of claim 12, further comprising rendering visualization of the plurality of analytic models corresponding to the at least one asset in a single view on the display device.

15. The method of claim 13, further comprising:
receiving metadata corresponding to a plurality of analytic models that are not enabled corresponding to the at least one asset; and
generating, based on the metadata and the knowledge graph data, a recommendation indicating applicability of at least one analytic model of the plurality of analytic models that are not enabled corresponding to the at least one asset.

16. The method of claim 15, further comprising displaying the generated recommendation on the display device.

17. The method of claim 12, further comprising determining at least one third party analytic model from among the plurality of analytic models, wherein the at least one third party analytic model is not disabled during the schedule for the maintenance of the at least one asset.

18. The method of claim 17, further comprising filtering a plurality of service cases generated corresponding to the at least one third party analytic model during the schedule for the maintenance of the at least one asset.

19. The method of claim 17, further comprising highlighting a plurality of service cases generated corresponding to the at least one third party analytic model during the schedule for the maintenance of the at least one asset.

20. A computer program product comprising at least one non-transitory computer-readable medium having computer-readable program instructions stored therein, the computer-readable program instructions comprising instructions, which when performed by at least one processor, configure the at least one processor to:
receive asset data corresponding to at least one asset of a plurality of assets;
determine a plurality of analytic models that are enabled corresponding to the at least one asset based on the received asset data;
determine that a maintenance is scheduled for the at least one asset;
disable at least one analytic model from the plurality of analytic models based on the determination;
re-enable the at least one analytic model after completion of the schedule for the maintenance of the at least one asset; and
render visualization of execution status of each of the plurality of analytic models corresponding to the at least one asset on a display device.
